(19) United States
(12) Patent Application Publication
(10) Pub. No.: US 2022/0032437 A1
(43) Pub. Date: Feb. 3, 2022

(54) IMPACT MECHANISM WITH MULTI-MATERIAL STRIKER

(71) Applicant: MILWAUKEE ELECTRIC TOOL CORPORATION, Brookfield, WI (US)

(72) Inventors: Will Didier, Cedarburg, WI (US); Tyler Young, Waukesha, WI (US); Kevin A. McLachlan, Brookfield, WI (US)

(21) Appl. No.: 17/392,386

(22) Filed: Aug. 3, 2021

Related U.S. Application Data
(60) Provisional application No. 63/060,209, filed on Aug. 3, 2020.

(51) Int. Cl. B25D 17/06; B25D 11/04

(52) U.S. Cl. CPC B25D 17/06; B25D 11/04; B25D 2217/0015; B25D 2250/375; B25D 2222/42; B25D 2222/51; B25D 2217/0023

(57) ABSTRACT

An impact mechanism for use in a power tool having a motor and adapted to impart axial impacts to a tool bit. The impact mechanism includes a piston configured to reciprocate in response to receiving torque from the motor, a striker that is selectively reciprocable within the spindle in response to reciprocation of the piston, and an anvil that is impacted by the striker when the striker reciprocates towards the tool bit. The anvil imparts axial impacts to the tool bit. The striker includes a body portion formed of a first material and an insert portion within the body portion. The insert portion is formed of a second material that is more dense than the first material.

### CROSS REFERENCE TO RELATED APPLICATION

This application claims the benefit of co-pending U.S. Provisional Patent Application No. 63/060,209, filed on Aug. 3, 2020, the entire content of which is incorporated herein by reference.

### FIELD OF THE INVENTION

The present invention relates to power tools, and more particularly to power tools having axial impact mechanisms.

### BACKGROUND OF THE INVENTION

Power tools, such as rotary hammers, include an axial impact mechanism having a reciprocating piston disposed within a spindle, a striker that is selectively reciprocable within the spindle in response to reciprocation of the piston, and an anvil that is impacted by the striker when the striker reciprocates toward the tool bit.

### SUMMARY OF THE INVENTION

The present invention provides, in one aspect, an impact mechanism for use in a power tool having a motor and adapted to impart axial impacts to a tool bit. The impact mechanism comprises a piston configured to reciprocate in response to receiving torque from the motor, a striker that is selectively reciprocable within the spindle in response to reciprocation of the piston, and an anvil that is impacted by the striker when the striker reciprocates towards the tool bit. The anvil imparts axial impacts to the tool bit. The striker includes a body portion formed of a first material and an insert portion within the body portion. The insert portion is formed of a second material that is more dense than the first material.

The present invention provides, in another aspect, a rotary hammer adapted to impart axial impacts to a tool bit. The rotary hammer comprises a housing, a motor supported by the housing and a spindle coupled to the motor for receiving torque from the motor, causing the spindle to rotate. The rotary hammer also includes a reciprocation mechanism operable to create a variable pressure air spring within the spindle. The reciprocation mechanism includes a piston configured to reciprocate within the spindle in response to receiving torque from the motor, a striker that is selectively reciprocable within the spindle in response to reciprocation of the piston, and an anvil that is impacted by the striker when the striker reciprocates towards the tool bit. The anvil imparts axial impacts to the tool bit. The rotary hammer also includes a bit retention assembly for securing the tool bit to the spindle. The striker includes a body portion formed of a first material and an insert portion within the body portion. The insert portion is formed of a second material that is more dense than the first material.

The present invention provides, in another aspect, a rotary hammer adapted to impart axial impacts to a tool bit. The rotary hammer includes a housing, a motor supported by the housing, a spindle coupled to the motor for receiving torque from the motor, causing the spindle to rotate and a reciprocation mechanism operable to create a variable pressure air spring within the spindle. The reciprocation mechanism includes a piston configured to reciprocate within the spindle in response to receiving torque from the motor and a striker that is selectively reciprocable within the spindle in response to reciprocation of the piston. The striker includes a nose at one end thereof and an anvil that is impacted by the nose of the striker when the striker reciprocates towards the tool bit. The anvil imparts axial impacts to the tool bit. The rotary hammer also includes a bit retention assembly for securing the tool bit to the spindle. The striker includes a body portion, which includes the nose, formed of a first material and an insert portion within an end of the body portion opposite the nose. The insert portion being formed of a second material that is more dense than the first material.

Other features and aspects of the invention will become apparent by consideration of the following detailed description and accompanying drawings.

### BRIEF DESCRIPTION OF THE DRAWINGS

FIG. 1 is a plan view of a rotary hammer.

FIG. 2 is a cross-sectional view of the rotary hammer of FIG. 1 with portions removed.

FIG. 3 is an enlarged plan view of the rotary hammer of FIG. 1 with portions removed.

FIG. 4 is a cross-sectional view of an electromagnetic clutch mechanism of the rotary hammer of FIG. 1.

FIG. 5 is an enlarged cross-sectional view of the electromagnetic clutch mechanism of FIG. 4.

FIG. 6 is a perspective view of a striker of the rotary hammer of FIG. 1.

FIG. 7 is a cross-sectional view of a striker of the rotary hammer of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

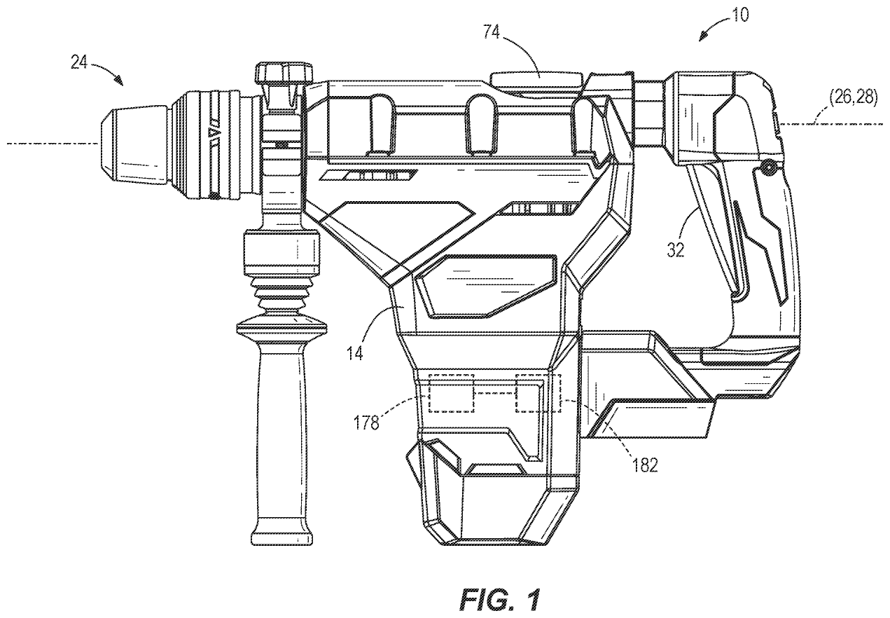

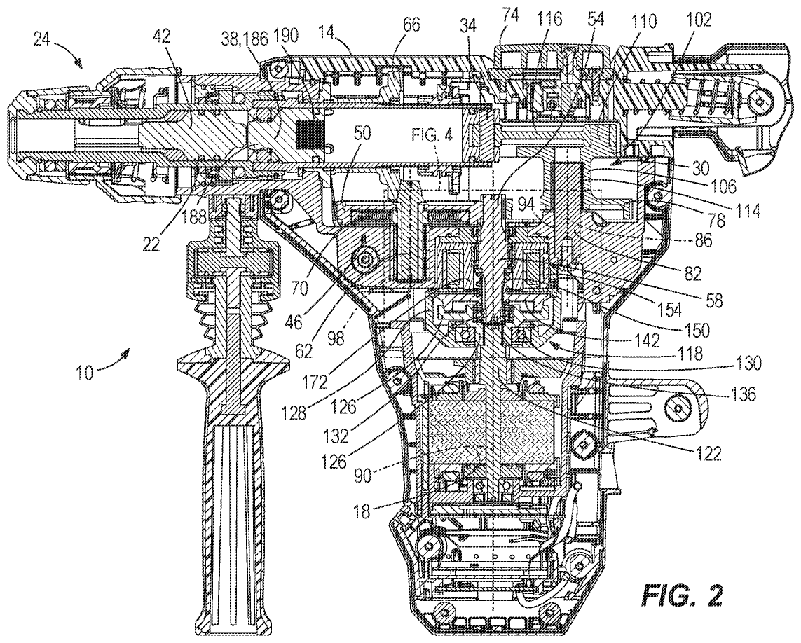

FIGS. 1 and 2 illustrate a rotary power tool, such as rotary hammer 10, according to an embodiment of the invention. The rotary hammer 10 includes a housing 14, a motor 18 disposed within the housing 14, and a rotatable spindle 22 coupled to the motor 18 for receiving torque from the motor 18. In the illustrated construction, the rotary hammer 10 includes a quick-release mechanism 24 coupled for co-rotation with the spindle 22 to facilitate quick removal and replacement of different tool bits. The tool bit may include a necked section or a groove in which a detent member of the quick-release mechanism 24 is received to constrain axial movement of the tool bit to the length of the necked section or groove. The rotary hammer 10 defines a tool bit axis 26, which in the illustrated embodiment is coaxial with a rotational axis 28 of the spindle 22.

The motor 18 is configured as a DC motor that receives power from an on-board power source (e.g., a battery, not shown). The battery may include any of a number of different nominal voltages (e.g., 12V, 18V, etc.), and may be configured having any of a number of different chemistries (e.g., lithium-ion, nickel-cadmium, etc.). In some embodiments, the battery is a battery pack removably coupled to the housing. Alternatively, the motor 18 may be powered by a remote power source (e.g., a household electrical outlet) through a power cord. The motor 18 is selectively activated by depressing an actuating member, such as a trigger 32, which in turn actuates an electrical switch. The switch is electrically connected to the motor 18 via a top-level or master controller 178, or one or more circuits, for controlling operation of the motor 18.

In some embodiments, the rotary hammer 10 is capable of producing an average long-duration power output between about 1000 Watts and about 1500 Watts. In other words, the rotary hammer 10 is operable to produce between about 2000 Watts and about 3000 Watts of power over a full discharge of a battery. In some embodiments, the rotary hammer 10 is capable of producing approximately 2100 Watts of power over a full discharge of a battery. In some embodiments, the rotary hammer delivers between 5 N-m and 25 N-m of torque at the tool bit. In other embodiments, the rotary hammer delivers approximately 80 N-m of torque at the tool bit.

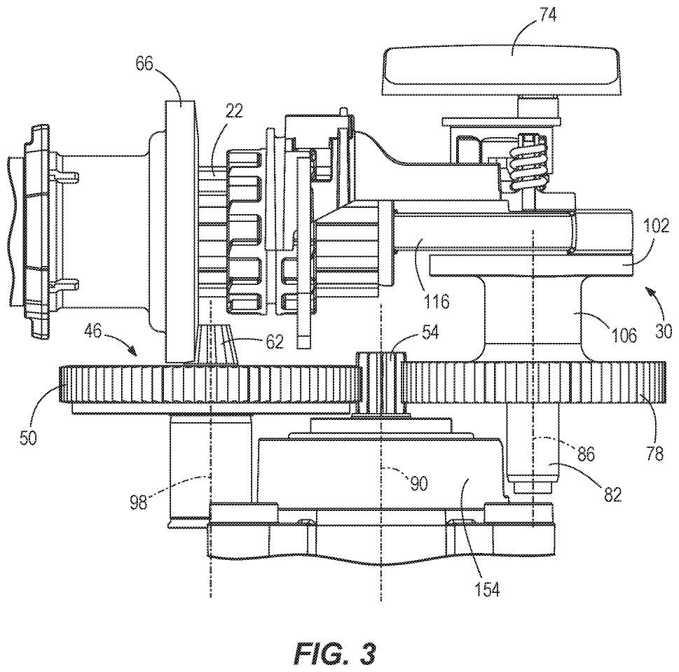

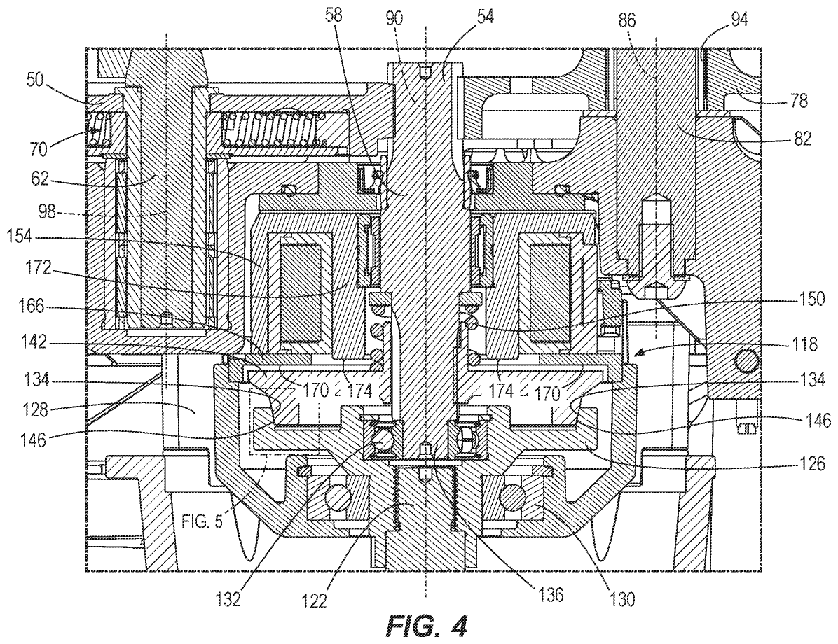

The rotary hammer 10 further includes an impact mechanism 30 (FIG. 2) having a reciprocating piston 34 disposed within the spindle 22, a striker 38 that is selectively reciprocable within the spindle 22 in response to reciprocation of the piston 34, and an anvil 42 that is impacted by the striker 38 when the striker reciprocates toward the tool bit. Torque from the motor 18 is transferred to the spindle 22 by a transmission 46 (FIG. 3). In the illustrated construction of the rotary hammer 10, the transmission 46 includes an input gear 50 engaged with a pinion 54 on an intermediate shaft 58 (FIG. 4) that is selectively driven by the motor 18, an intermediate pinion 62 coupled for co-rotation with the input gear 50, and an output gear 66 coupled for co-rotation with the spindle 22 and engaged with the intermediate pinion 62. The output gear 66 is secured to the spindle 22 using a spline-fit or a key and keyway arrangement, for example, that facilitates axial movement of the spindle 22 relative to the output gear 66 yet prevents relative rotation between the spindle 22 and the output gear 66. A clutch mechanism 70 is incorporated with the input gear 50 to limit the amount of torque that may be transferred from the motor 18 to the spindle 22.

The impact mechanism 30 is driven by another input gear 78 that is rotatably supported within the housing 14 on a stationary intermediate shaft 82, which defines a central axis 86 that is offset from a rotational axis 90 of the intermediate shaft 58 and pinion 54. A bearing 94 (e.g., a roller bearing, a bushing, etc.; FIG. 1) rotatably supports the input gear 78 on the stationary intermediate shaft 82. As shown in FIG. 1, the respective axes 86, 90 of the intermediate shaft 82 and intermediate shaft 58 are parallel. Likewise, respective axes 90, 98 of the intermediate shaft 58 and the intermediate pinion 62 are also parallel. The impact mechanism 30 also includes a crank shaft 102 having a hub 106 and an eccentric pin 110 coupled to the hub 106. The hub 106 is rotatably supported on the stationary shaft 82 above the input gear 78 by a bearing 114 (e.g., a roller bearing, a bushing, etc.). The impact mechanism 30 further includes a connecting rod 116 interconnecting the piston 34 and the eccentric pin 110. In other embodiments, instead of the crank shaft 102, hub 106, eccentric pin 110, and connecting rod 116, a wobble bearing and plate could be used to transfer torque from the motor 18 into reciprocation of the piston 34.

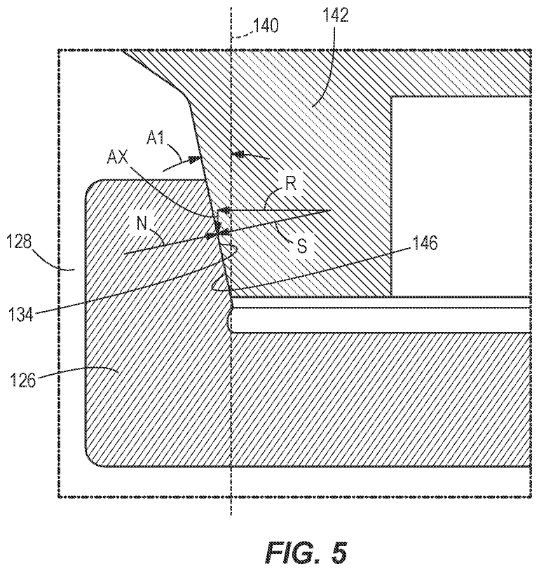

As shown in FIGS. 4 and 5, the rotary hammer 10 includes an electromagnetic clutch mechanism 118 upstream of the clutch mechanism 70 for transferring torque from an output shaft 122 of the motor 18 to the intermediate shaft 58. When driven by the motor 18, the output shaft 122 rotates about the axis 90. The electromagnetic clutch mechanism 118 includes an input member, such as a clutch driver 126, that is coupled to the output shaft 122 of the motor 18 for co-rotation therewith. A bearing 130 rotatably supports the clutch driver 126 within a gear case 128. Another bearing 132 is arranged within the clutch driver 126 to rotatably support a distal end 136 of the intermediate shaft 58 opposite the pinion 54.

As shown in FIG. 5, the clutch driver 126 has a first surface 134 that defines an acute angle A1 with respect to the axis 90. For illustration purposes, a reference axis 140 that is parallel to axis 90 has been shown in FIG. 5 to illustrate the angle A1. In some embodiments, the angle A1 is between 0 degrees and about 24 degrees. In other embodiments, the angle A1 is between about 10 degrees and about 15 degrees. In some embodiments, the angle A1 is approximately 12 degrees. In some embodiments, such as the one shown, the first surface 134 is a conical surface.

With continued reference to FIGS. 4 and 5, the electromagnetic clutch mechanism 118 also includes an output member, such as a clutch plate 142, that is coupled to the intermediate shaft 58 so that the intermediate shaft 58 co-rotates with the clutch plate 142. In some embodiments, the intermediate shaft 58 is splined and the clutch plate 142 is secured to the intermediate shaft 58 via a spline fit, such that the clutch plate 142 is axially movable with respect to the intermediate shaft 58 but cannot rotate relative to the intermediate shaft 58. The clutch plate 142 includes a second surface 146 (FIG. 5) that is configured to frictionally engage the first surface 134 of the clutch driver 126. In some embodiments, the second surface 146 is a conical surface.

The clutch plate 142 is axially moveable with respect to the clutch driver 126 and is biased by a spring 150 into a first position shown in FIGS. 4 and 5, in which the clutch plate 142 is engaged with the clutch driver 126 for co-rotation therewith. In the first or “driven” position of the clutch plate 142, the co-rotational engagement between the clutch driver 126 and the clutch plate 142 occurs as a result of a frictional force developed between the surfaces 134, 146 from an applied force S imparted by the spring 150 and transferred through the clutch plate 142. As shown in FIG. 5, the spring force S can be resolved into a radial force R oriented perpendicular to the axis 140 and axial force AX that is parallel with the axis 140. In response, the clutch driver 126 applies a normal force N against the second surface 146 of the clutch plate 142 along the same line of action as the spring force S, thereby creating friction between the clutch driver 126 and the clutch plate 142, rotationally unitizing the clutch driver 126 and the clutch plate 142. The selection of angle A1 allows for a sufficient amount of torque transmission during operation while yielding a small enough radial force R that the clutch driver 126 does not flex or deflect.

With reference to FIG. 4, the electromagnetic clutch mechanism 118 also includes an electromagnet 154 that is arranged about the intermediate shaft 58. In some embodiments, the electromagnet 154 is arranged within the intermediate shaft 58. A ring-shaped brake member 166 is arranged between the electromagnet 154 and the clutch plate 142. The brake member 166 has a braking surface 170 that faces in the direction of the clutch plate 142. A core 172 of the electromagnet 154 also has a braking surface 174 that is coplanar with braking surface 170 and faces in the direction of the clutch plate 142.

As shown schematically in FIG. 1, the rotary hammer 10 also includes a controller 178 and a 9-axis sensor 182, such as a gyroscope, an accelerometer, or a magnetometer configured to determine the relative orientation and movement of the housing 14 about the tool bit axis 26. The controller 182 is electrically connected with the motor 18, the sensor 182, and the electromagnet 154. During operation of the rotary hammer 10, it is possible for the tool bit to become seized in concrete or other material. However, because the motor 18 continues transmitting torque to the spindle 22, the rotary hammer 10 can suddenly and unexpectedly rotate about the tool bit axis 26. As described further below, the electromagnetic clutch mechanism 118 substantially prevents this from happening.

With reference to FIG. 1, the rotary hammer 10 includes a mode selection member 74 rotatable by an operator to switch between two modes. In a “hammer-drill” mode, the motor 18 is drivably coupled to the piston 34 for reciprocating the piston 34 while the spindle 22 rotates. In a “hammer-only” mode, the motor 18 is drivably coupled to the piston 34 for reciprocating the piston 34 but the spindle 22 does not rotate.

In operation, an operator selects hammer-drill mode with the mode selection member 74. The operator then depresses the trigger 32 to activate the motor 18. The electromagnet 154 is initially de-energized and the clutch plate 142 is biased into the first position, causing the electromagnetic clutch mechanism 118 to be in a first state in which the clutch plate 142 frictionally engages the clutch driver 126 via the first and second surfaces 134, 146 as described above. The motor output shaft 122 rotates the clutch driver 126, which causes the clutch plate 142 and the intermediate shaft 58 to co-rotate with the motor shaft 122, allowing the clutch plate 142 to receive torque from the motor 18. The rotation of the pinion 54 of the intermediate shaft 58 causes the input gear 50 to rotate. Rotation of the input gear 50 causes the intermediate pinion 62 to rotate, which drives the output gear 66 on the spindle 22, causing the spindle 22 and the tool bit to rotate.

Rotation of the pinion 54 also causes the input gear 78 to rotate about the intermediate shaft 82, which causes the crank shaft 102 and the eccentric pin 110 to rotate as well. If “hammer-drill” mode has been selected, rotation of the eccentric pin 110 causes the piston 34 to reciprocate within the spindle 22 via the connecting rod 116, which causes the striker 38 to impart axial blows to the anvil 42, which in turn causes reciprocation of the tool bit against a workpiece. Specifically, a variable pressure air pocket (or an air spring) is developed between the piston 34 and the striker 38 when the piston 34 reciprocates within the spindle 22, whereby expansion and contraction of the air pocket induces reciprocation of the striker 38. The impact between the striker 38 and the anvil 42 is then transferred to the tool bit, causing it to reciprocate for performing work on workpiece.

During operation of the rotary hammer 10 in hammer-drill mode, the controller 178 repeatedly samples the output of the 9-axis sensor 182 to measure the rotational speed (i.e., in degrees of rotation per second) of the housing 14 about the tool bit axis 26. In some embodiments, the controller 178 measures the rotational speed of the housing 14 about the tool bit axis 26 every five milliseconds. If, during operation, a condition is detected, such as the rotational speed of the rotary hammer 10 exceeding a threshold value for a predetermined consecutive number of samples, the controller 178 energizes the electromagnet 154. As a result of the electromagnetic force developed by the electromagnet 154 and applied to the clutch plate 142, the clutch plate 142 is translated along the intermediate shaft 158, against the bias of the spring 150, from the first or driven position to a second position, causing the electromagnetic clutch mechanism 118 to be in a second state in which the clutch plate 142 is disengaged from the clutch driver 126. Because the clutch plate 142 is no longer engaged with the clutch driver 126, the clutch plate 142 no longer receives torque from the motor 18.

In the second state of the electromagnetic clutch mechanism 118, corresponding to the second or disengaged position of the clutch plate 142, the clutch plate 142 is braked via frictional contact with the braking surfaces 170, 174 of the brake member 166 and the core 172, respectively, thereby rapidly decelerating rotation of the clutch plate 142. Because the clutch plate 142 is coupled for co-rotation with the intermediate shaft 58, rotation of the intermediate shafts 58, 62, the output gear 66, and the spindle 22 is also rapidly decelerated and brought to a stop. In this manner, if the housing 14 is rotated too quickly about the tool bit axis 26, the controller 178 quickly detects this event and disengages the electromagnetic clutch mechanism 118 to quickly discontinue rotation of the spindle 22. Also, if an operator releases the trigger 32, the electromagnetic clutch mechanism 118 is disengaged in the same manner as described above. Because the condition is accurately detected when the sensor 182 senses that the rotational speed of the housing 14 exceeds a threshold value, the electromagnetic clutch mechanism 118 reduces or eliminates nuisance shutdowns.

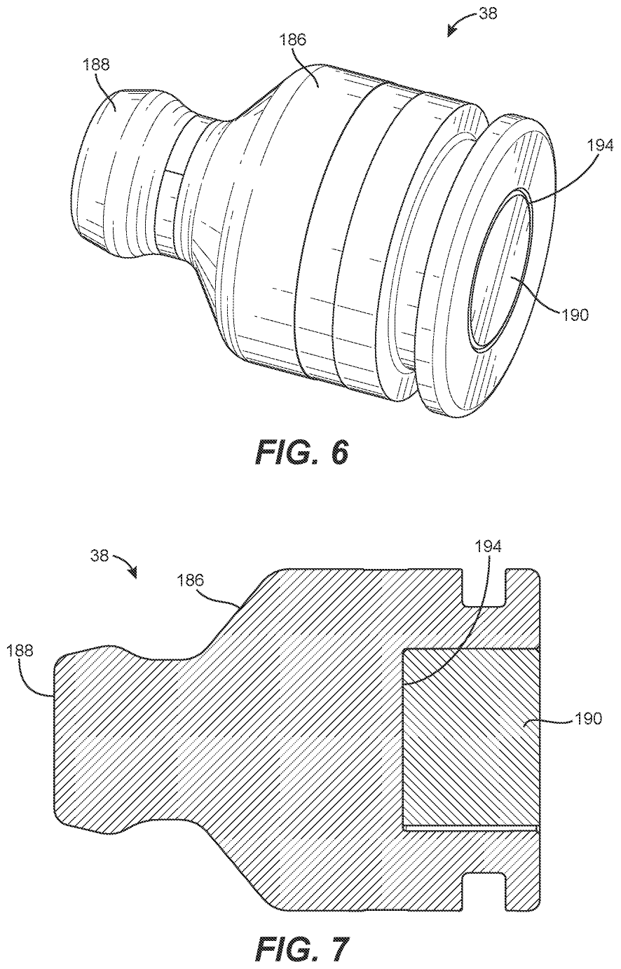

FIGS. 6 and 7 show the striker 38 in more detail. Specifically, the striker 38 has a body portion 186 and an insert portion 190. The body portion 186 is formed of a first material, such as alloy steel 8620, and includes a nose 188 that delivers the impacts to the anvil 42. The insert portion 190 is formed of a second material that is different from the first material. In some embodiments, the second material is more dense than the first material. For example, in some embodiments, the first material is steel and the second material is tungsten carbide or another material that is also more dense than steel. In other embodiments, the second material is less dense than the first material. For example, in some embodiments, the first material is steel and the second material is aluminum or another material that is also less dense than steel. Regardless of whether the second material is more or less dense than the first material, the second material is selected to maintain an ideal geometry of the striker 38, while precisely controlling the mass of the striker 38. Thus, the second material can be selected to manipulate the kinematics of the impact mechanism 30 to improve performance by increasing impact energy or increasing a rate of drilling through concrete.

Thus, the striker 38 is formed of two different materials and is therefore a multi-material striker, and more specifically, in this embodiment, a dual-material striker. To assemble the striker 38, the insert portion 190 is pressed (e.g., press fit) into a rear cavity 194 of the body portion 194. In the illustrated embodiment, the insert portion 190 is a cylindrical slug and the rear cavity 194 is cylindrical, but in other embodiments, the insert portion and rear cavity 194 could have different shapes.

Because tungsten carbide is denser than steel, by inserting the insert portion 190 formed of tungsten carbide into the body portion 186 (which is formed of steel), the dual-material striker 38 is heavier than an identically sized striker formed entirely of steel. Increasing the mass of striker 38 increases the impact energy of the striker 38 as it delivers repeated axial impacts to the anvil 42, without increasing the size or changing the geometry of the striker 38. The dual-material striker 38 is also advantageous because the manufacturability of the striker 38 is relatively unchanged and the material properties (i.e., fatigue strength and ductility) remain the same for the striker 38. The dual-material striker 38 can be alternatively used in other applications besides the rotary hammer 10. For example, the dual-material striker 38 could be used in a percussion or demolition hammer, in which rotation is not applied to the tool bit (e.g., a chisel).

Various features and advantages are set forth in the following claims.

What is claimed is:

1. An impact mechanism for use in a power tool having a motor and adapted to impart axial impacts to a tool bit, the impact mechanism comprising:
a piston configured to reciprocate in response to receiving torque from the motor;
a striker that is selectively reciprocable within the spindle in response to reciprocation of the piston; and
an anvil that is impacted by the striker when the striker reciprocates towards the tool bit, the anvil imparting axial impacts to the tool bit,
wherein the striker includes a body portion formed of a first material and an insert portion within the body portion, the insert portion being formed of a second material that is more dense than the first material.

2. The impact mechanism of claim 1, wherein the insert portion is a cylindrical slug.

3. The impact mechanism of claim 1, wherein the body portion includes a cavity into which the insert portion is received.

4. The impact mechanism of claim 3, wherein the insert portion is a cylindrical slug, and wherein the cavity has a cylindrical shape to receive the cylindrical slug.

5. The impact mechanism of claim 1, wherein the first material is steel, and wherein the second material is tungsten carbide.

6. The impact mechanism of claim 1, wherein the striker includes a nose that impacts the anvil.

7. The impact mechanism of claim 6, wherein the insert portion is positioned within the body portion on a side of the striker that is opposite the nose.

8. The impact mechanism of claim 1, wherein the impact mechanism is disposed within a spindle of the power tool.

9. The impact mechanism of claim 8, wherein the piston is operable to create a variable pressure air spring within the spindle.

10. The impact mechanism of claim 1, wherein the insert portion is press fit into the body portion.

11. A rotary hammer adapted to impart axial impacts to a tool bit, the rotary hammer comprising:
a housing;
a motor supported by the housing;
a spindle coupled to the motor for receiving torque from the motor, causing the spindle to rotate;
a reciprocation mechanism operable to create a variable pressure air spring within the spindle, the reciprocation mechanism including
a piston configured to reciprocate within the spindle in response to receiving torque from the motor,
a striker that is selectively reciprocable within the spindle in response to reciprocation of the piston, and
an anvil that is impacted by the striker when the striker reciprocates towards the tool bit, the anvil imparting axial impacts to the tool bit; and
a bit retention assembly for securing the tool bit to the spindle,
wherein the striker includes a body portion formed of a first material and an insert portion within the body portion, the insert portion being formed of a second material that is more dense than the first material.

12. The rotary hammer of claim 11, wherein the insert portion is a cylindrical slug.

13. The rotary hammer of claim 11, wherein the body portion includes a cavity into which the insert portion is received.

14. The rotary hammer of claim 13, wherein the insert portion is a cylindrical slug, and wherein the cavity has a cylindrical shape to receive the cylindrical slug.

15. The rotary hammer of claim 11, wherein the first material is steel, and wherein the second material is tungsten carbide.

16. The rotary hammer of claim 11, wherein the striker includes a nose that impacts the anvil.

17. The rotary hammer of claim 16, wherein the insert portion is positioned within the body portion on a side of the striker that is opposite the nose.

18. The rotary hammer of claim 11, wherein the insert portion is press fit into the body portion.

19. A rotary hammer adapted to impart axial impacts to a tool bit, the rotary hammer comprising:
a housing;
a motor supported by the housing;
a spindle coupled to the motor for receiving torque from the motor, causing the spindle to rotate;
a reciprocation mechanism operable to create a variable pressure air spring within the spindle, the reciprocation mechanism including
a piston configured to reciprocate within the spindle in response to receiving torque from the motor,
a striker that is selectively reciprocable within the spindle in response to reciprocation of the piston, the striker including a nose at one end thereof, and
an anvil that is impacted by the nose of the striker when the striker reciprocates towards the tool bit, the anvil imparting axial impacts to the tool bit; and
a bit retention assembly for securing the tool bit to the spindle,
wherein the striker includes
a body portion, which includes the nose, formed of a first material, and
an insert portion within an end of the body portion opposite the nose, the insert portion being formed of a second material that is more dense than the first material.

20. The rotary hammer of claim 19, wherein the first material is steel, wherein the second material is tungsten carbide, wherein the insert portion is a cylindrical slug, and wherein the body portion includes a cylindrical cavity in which the cylindrical slug is received.
